(19) United States
(12) Patent Application Publication
(10) Pub. No.: US 2025/0012228 A1
(43) Pub. Date: Jan. 9, 2025

(54) HIGH PRESSURE FUEL SYSTEM CONTROLS, DIAGNOSTICS, AND PROGNOSTICS USING FUEL MASS CHANGE ESTIMATES

(71) Applicant: Cummins Inc., Columbus, IN (US)

(72) Inventor: Donald J. Benson, Columbus, IN (US)

(21) Appl. No.: 18/713,286

(22) PCT Filed: Nov. 30, 2021
(86) PCT No.: PCT/US2021/072630

§ 371 Date: May 24, 2024

(51) Int. Cl. F02D 41/22; F02D 41/38

(52) U.S. Cl. CPC F02D 41/22; F02D 41/3809; F02D 2041/224; F02D 2041/389; F02D 2200/0602

(57) ABSTRACT

A method includes operating a pump to pump fuel to a rail and concurrently operating one or more injectors to inject fuel from the rail into one or more cylinders of an engine. The method further includes filtering measurements of fuel pressure of the rail to determine filtered pressures for at least a first pressure measurement zone preceding a target event and a second pressure measurement zone succeeding a target fuel mass change event, determining a pressure change in response to the filtered pressures, and determining a fuel mass change of the target event in response to the pressure change.

### CROSS-REFERENCE

This application claims priority to and the benefit of International Patent Application No. PCT/US21/72630, filed Nov. 30, 2021, which is hereby incorporated by reference in its entirety.

### TECHNICAL FIELD

The present application relates to high pressure fuel system controls, diagnostics, and prognostics using fuel mass change estimates and to related apparatuses, methods, systems, and techniques.

### BACKGROUND

High pressure fuel systems generally include a high pressure pump configured to supply pressurized fuel to a fuel rail and one or more injectors configured to inject fuel from the fuel rail into a respective engine cylinder. A number of proposals have been made for controlling and performing diagnostics or prognostics of high pressure fuel systems. Such proposals suffer from a number of drawbacks, disadvantages, shortcomings, and unmet needs. For example, such proposals may require disabling, modifying, or interrupting operation of one fuel system component, such as a high pressure pump, in order to evaluate another fuel system component, such as an injector. Such proposals may require other types of atypical or modified system operation or may be limited to certain engine or fuel system operating conditions. Such proposals may be limited in accuracy, precision, range of operation, reliability, and robustness of control, diagnostic, and prognostic operations for high pressure fuel systems. In view of these and other drawbacks, disadvantages, shortcomings, and unmet needs, there remains a significant need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique apparatuses utilizing fuel mass change estimates for high pressure fuel system controls, diagnostics, and prognostics. Some embodiments include unique methods utilizing fuel mass change estimates for high pressure fuel system controls, diagnostics, and prognostics. Some embodiments include unique systems utilizing fuel mass change estimates for high pressure fuel system controls, diagnostics, and prognostics. Further embodiments, forms, and features of the present disclosure shall become apparent from the following description and drawings.

### BRIEF DESCRIPTION OF THE DRAWINGS

FIG. 1 is a schematic diagram illustrating certain aspects of an example engine system including an example fuel injection system.

FIG. 2 is a schematic diagram illustrating certain aspects of example engine system controls.

FIG. 3 is a schematic diagram illustrating certain aspects of example engine system controls.

FIG. 4 is a schematic diagram illustrating certain aspects of example engine system controls.

FIG. 5 is a flow diagram illustrating certain aspects of an example engine system control method.

FIG. 6 is a graph illustrating certain aspects of example pumping patterns for a plurality of engine cycles for an example engine system including precessing fuel pump.

FIG. 7 is a graph illustrating a pump and injection pattern for one engine cycle of the plurality of engine cycles of FIG. 6.

FIG. 7A is an enlarged portion of FIG. 7.

FIG. 8 is a graph illustrating a pump and injection pattern for another engine cycle of the plurality of engine cycles of FIG. 6.

FIG. 8A is an enlarged portion of FIG. 8.

FIG. 9 is a graph illustrating a pump and injection pattern for yet another engine cycle of the plurality of engine cycles of FIG. 6.

FIG. 9A is an enlarged portion of FIG. 9.

### DETAILED DESCRIPTION OF EXAMPLE EMBODIMENTS

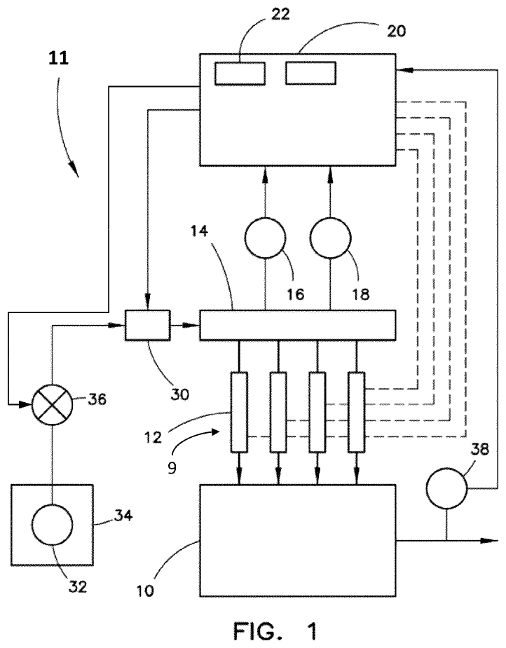

With reference to FIG. 1, there is illustrated an engine system 11 comprising an engine 10 including a fuel injection system 9 including one or more fuel injectors 12. The engine 10 may be an internal combustion engine, including but not limited to a compression-ignition engine, using diesel or other suitable fuel, or a spark-ignition engine, using gasoline, natural gas, or other suitable fuels. Engine 10 may have one or more combustion cylinders (not depicted) to generate mechanical power from the combustion of a fuel. The fuel injectors 12 are in fluid communication with respective combustion cylinders of the engine 10 and are structured to introduce the fuel into respective combustion cylinders. Though four fuel injectors 12 are depicted in FIG. 1, engine 10 may include fewer or greater numbers of fuel injectors 12. In certain embodiments, engine 10 may include one fuel injector 12 for each cylinder. In the illustrated embodiment, the fuel injection system 9 is configured and provided as a high pressure common-rail fuel injection system wherein the fuel injectors 12 are in fluid communication with a common fuel rail 14, which supplies fuel at relatively high pressure to each fuel injector 12.

Fuel may be supplied to the common fuel rail 14 by a high pressure pump 30. In certain embodiments, the high pressure pump 30 may be fed by a relatively low-pressure fuel circuit including a booster pump 32, which may be provided in a tank 34 containing the fuel. A fuel regulator 36, such as a variable valve or an on/off valve, may control the flow of fuel to the high pressure pump 30 to, in turn, control the flow of fuel from the high pressure pump 30 to the common fuel rail 14.

Engine system 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 may include one or more modules 22 configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the engine system 11. For example, the sensors may include a pressure sensor 16 and a temperature sensor 18. The pressure sensor 16 is in communication with the common fuel rail 14 and structured to communicate a measurement of the pressure within the common fuel rail 14 to the ECS 20. The temperature sensor 18 is in communication with the common fuel rail 14 and structured to communicate a measurement of the temperature within the common fuel rail 14 to the ECS 20. In at least one embodiment, engine system 11 may include an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the engine system 11. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

Engine system 11 includes an example embodiment of a high pressure fuel system according to the present disclosure which includes high pressure pump 30, common fuel rail 14, and fuel injectors 12. A number of additional and alternative embodiments of a high pressure fuel system are also contemplated. For example, while engine system 11 comprises an example high pressure common rail system including common fuel rail 14, other forms of fuel rails, sometimes referred to as bores, galleries, manifolds, or rifles, may be utilized in other embodiments. Additionally, while engine system 11 is depicted as having four fuel injectors 12, another number of one or more fuel injectors may be present in various embodiments. In some embodiments, high pressure pump 30 may be provided in a precessing form in which the relative phasing between the high pressure pump and the engine changes for successive engine cycles and repeats over a predetermined number of engine cycles. Relative phasing of the high pressure pump and the engine may be described by a phase angle between a pump position (e.g., a pump piston top dead center, another pump piston location, or a position of another cyclical pump component or element) and an engine position (e.g., an engine piston top dead center, another engine piston location, or a position of another cyclical engine component or element). In some embodiments, high pressure pump 30 may be provided a non-precessing form in which relative phasing of the high pressure pump and the engine remains constant.

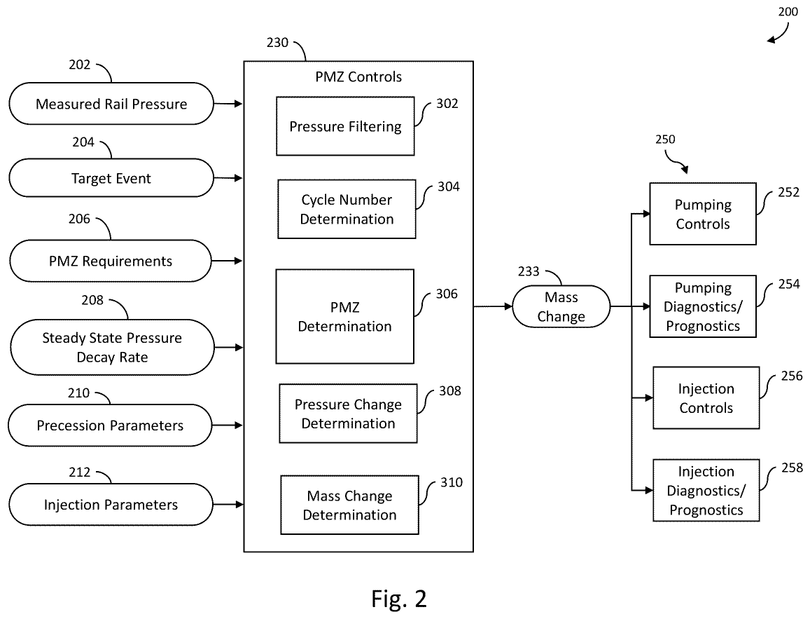

With reference to FIG. 2, there are illustrated example engine system controls 200 which may be implemented in one or more components of an electronic control system such as ECS 20 of engine system 11, another electronic control system of engine system 11, or another electronic control system of another engine system. For purposes of illustration, engine system controls 200 are described in connection with a system including a precessing high pressure fuel pump, it being understood that engine system controls 200 may also be utilized for a system including a non-precessing high pressure fuel pump with certain modifications.

Engine system controls 200 include pressure measurement zone (PMZ) controls 230 which are configured and operable to receive as inputs measured rail pressure 202, target event 204, pressure measurement zone (PMZ) requirements 206, steady state pressure decay rate 208, precession parameters 210, and injection parameters 212 and, in response to the received inputs, determine fuel mass change 233. In the example embodiment of FIG. 2, PMZ controls are illustrated as including pressure filtering controls 302, cycle number determination controls 304, PMZ determination controls 306, pressure change determination controls 308, and fuel mass change determination controls 310. While pressure filtering controls 302, cycle number determination controls 304, PMZ determination controls 306, pressure change determination controls 308, and fuel mass change determination controls 310 are depicted as distinct blocks or components of PMZ controls 230 for purposes of illustration, it shall be appreciated that they may be implemented in various forms in which their respective controls, logic, function, and operations may be combined in common blocks or components, separated into multiple blocks or components, repeated in multiple instances or among multiple blocks or components, or provided separately from, while still being accessed and utilized by PMZ controls 230.

Measured rail pressure 202 corresponds to output of a pressure sensor configured and operable to measure pressure of fuel in a fuel rail, such as pressure sensor 16 and common fuel rail 14 of engine system 11 or a pressure sensor and a fuel rail of another system. The value of measured rail pressure 202 may be updated over time, for example, in some embodiments the value of measured rail pressure 202 may be updated at a frequency of 10 kHz. Other embodiments may update the value of measured rail pressure 202 at other frequencies or at other intervals or rates which are not necessarily periodic with respect to time or otherwise.

Target event 204 is an example of a target fuel mass change event which identifies a particular fuel mass change event for which a fuel mass change is to be determined. Target event 204 may be set (e.g., established, determined, changed, selected, written, or otherwise set) by engine system controls 200 (or one or more other components of an electronic control system) to a number of values corresponding to different fuel mass change events, for example, a first set of values for target event 204 may be utilize to indicate injection events performed by a particular injector of a plurality of injectors and a second set of values for target event may be utilized to indicate a pumping event performed by a high pressure fuel pump or a particular pumping event of a plurality of pumping events performed by a high pressure fuel pump. The value of target event 204 may be set multiple times during operation of engine system controls 200 so that PMZ controls 230 operates with respect to multiple target events of a plurality of potential target events. For example, the value of target event 204 may be set multiple times so that PMZ controls 230 operates with respect to all potential target events of the plurality of target events and/or may set the value of target event 204 multiple times for any one or more of the plurality of potential target events.

PMZ requirements 206 indicate one or more pressure change requirements indicating characteristics required of a pressure measurement zone. PMZ requirements 206 may, for example, indicate a maximum pressure change limit (e.g., a maximum deviation from a nominal pressure change) imposed on a pressure measurement zone and a minimum number of pressure measurements required to occur in a pressure measurement zone. The maximum pressure change limit and the minimum number of pressure measurements required to occur in a pressure measurement are one example of a pressure stability criterion or requirement. PMZ requirements 206 may establish these and other criteria against which PMZ controls 230 may determine and identify one or more pressure measurement zones. Thus, for example, PMZ requirements 206 may require that a pressure measurement zone comprise a minimum number of consecutive pressure measurements exhibiting not more than a maximum pressure change in order to determine a pressure measurement zone or to accept a candidate pressure measurement zone as a predicted pressure measurement zone.

Steady state pressure decay rate 208 indicates a pressure decay rate for the fuel rail during steady state conditions of the pressure rail in which neither an injection event nor a pumping event occurs. Such pressure decay may occur due to inherent characteristics or properties of a given fuel system (e.g., a nominal leakage rate) or due to malfunction of a given fuel system (e.g. leakage above a nominal leakage rate). Steady state pressure decay rate 208 may be utilized as the nominal pressure change relative to which the maximum pressure change limit may be established. Steady state pressure decay rate 208 may be a predetermined value or a variable value which may be updated over time in response to pressure measurements of fuel rail pressure under steady state conditions from which increased leakage in a given fuel system may be determined or estimated.

Precession parameters 210 indicate information of a pumping pattern having a precessing relationship between high pressure fuel pump position and engine position. As stated above, a high pressure pump may be provided in a precessing form in which the relative phasing between the high pressure pump and the engine changes for successive engine cycles and repeats over a predetermined number of engine cycles.

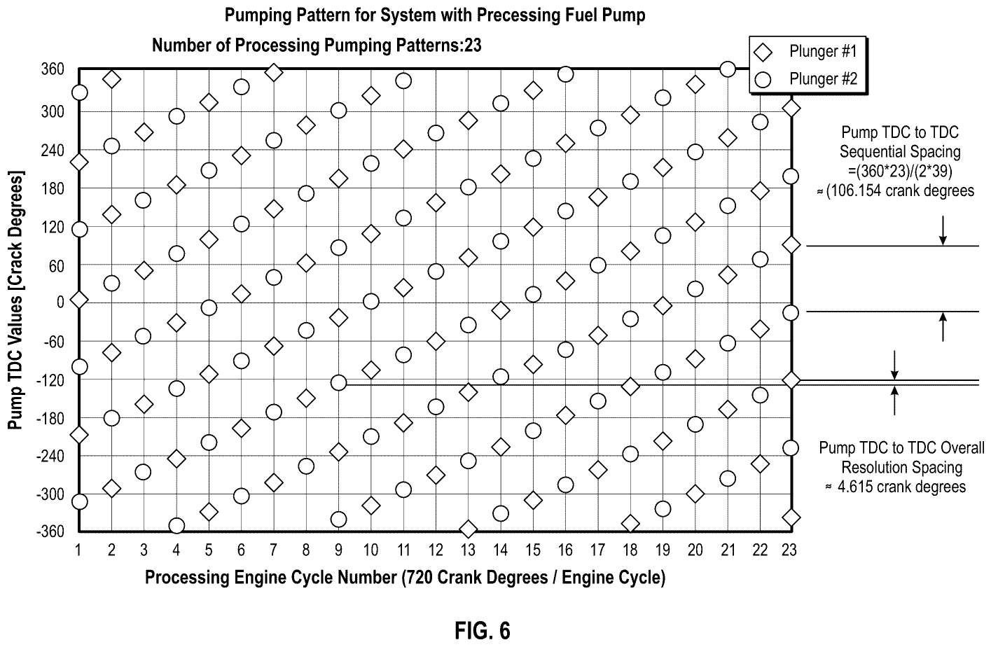

With reference to FIG. 6, there is illustrated a graph 600 depicting a pumping pattern for an example system with relative pump and engine position precession, also referred to herein as a precessing fuel pump. The example system includes a 4-cycle engine and a fuel pump having two pumping plungers which are driven by respective cam lobes in an alternating pumping sequence. The example system has an engine crankshaft gear with 39 driving teeth and a high pressure pump gear with 23 driven teeth resulting in a high pressure pump to engine speed ratio of 39/23 which is approximately equal to 1.696. The relative phasing of the pump to the engine precesses after each sequential 720 degree engine cycle and repeats for every 23 engine cycles. For any given engine cycle, the sequential pumping event to pumping event top dead center (TDC) spacing is approximately 106.154 engine crankshaft degrees. For all of the 23 unique patterns collectively, the pumping event to pumping event top dead center (TDC) spacing is approximately 4.62 engine crankshaft degrees which may be referred to as the overall resolution spacing.

Precession parameters 210 may be predetermined and stored by, accessed by, or provided to engine system controls 200 based on the configuration of a given engine and fuel system design. The number of engine cycles required for the pumping and injection event relative phasing to complete a full precession cycle can be calculated based on the design parameters of a given system. In principle precession parameters 210 could be additionally or alternatively dynamically determined by engine system controls 200, or verified by engine system controls 200 by monitoring operation of an engine and fuel injection system.

Injection parameters 212 indicate a number of commanded injection parameters such as injection amount, injection start time, and injector on time associated with one or more injection events. Injection parameters 212 may be provided for one or more injection events associated with operation of each injector of a given system and may be dynamically modified in response as other injection system controls vary the amount and timing of commanded injections. Injection parameters 212 may be determined in response to load demands placed on an engine, for example, accelerator pedal demands, cruise control system demands, accessory demands, or other load demands on the engine.

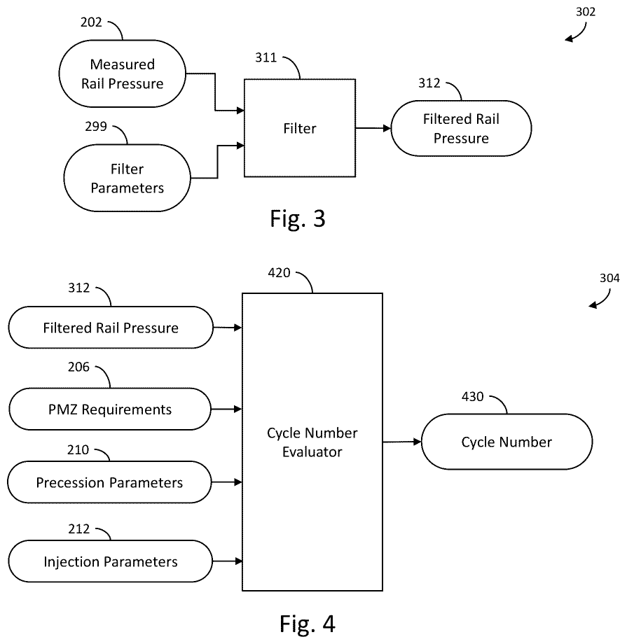

Pressure filtering controls 302 may receive as input measured rail pressure 202 and perform one or more filtering operations on the received input. With reference to FIG. 3, there is illustrated example controls which may be implemented in and operated by pressure filtering controls 302 to perform filtering of measured rail pressure 202. In the illustrated example, filter 311 receives as input measured rail pressure 202 and filter parameters 299 and determines and provides as output filtered rail pressure 312. Filter 311 may be provided in a number of forms which are configured to filter (e.g., mitigate or remove) noise or other confounding components from the measured rail pressure 202 to improve measurement of a pressure signal of interest. For example, filter 311 may be provided in a number of forms which are configured to filter ringing or oscillation components which may occur at a higher frequency than a pressure signal of interest. Thus, filtered rail pressure 312 may indicate the pressure signal of interest with reduced ringing or oscillation components. Such ringing or oscillation components may be attributable to system dynamics, for example, the introduction of fuel mass into a fuel rail by a high pressure fuel pump, or the removal of fuel mass from a fuel rail by a fuel injector. In some embodiments filter 311 may be configured and provided as an exponential moving average filter. In some forms, the exponential moving average filter may be of a multiple-frequency, damped input type. Filter parameters 299 indicate values for filter constants or other tunable parameters of filter 311. For example, filter parameters may indicate estimates of a natural system frequency and damping factors which may be utilized by a multiple-frequency, damped input-type exponential moving average filter. As will occur to one of skill in the art with the benefit and insight of the present disclosure, filter 311 and filter parameters 299 may be provided in a variety of other forms adapted to mitigate or remove from a measured rail pressure ringing or oscillation components which are particular to the specific characteristics of a given system design, and current operating states of the engine, engine operating environment and fuel system.

With reference to FIG. 4, there is illustrated an example embodiment of cycle number determination controls 304. Cycle number determination controls 304 may include cycle number evaluator 420 which receives as input filtered rail pressure 312, PMZ requirements 206, precession parameters 210, and injection parameters 212 and determines and outputs cycle number 430 in response to the received inputs. Cycle number 430 may indicate which of the plurality of precessing engine cycles (e.g., a particular one of the 23 precessing engine cycles depicted in graph 600) constitutes the current engine cycle or which engine cycle in a precession pattern is occurring at a given time.

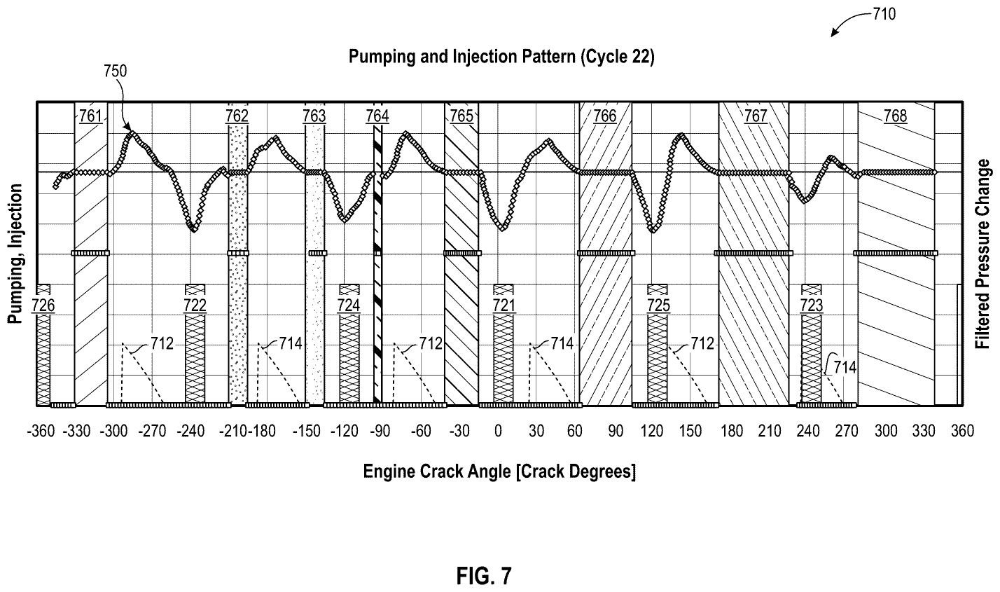

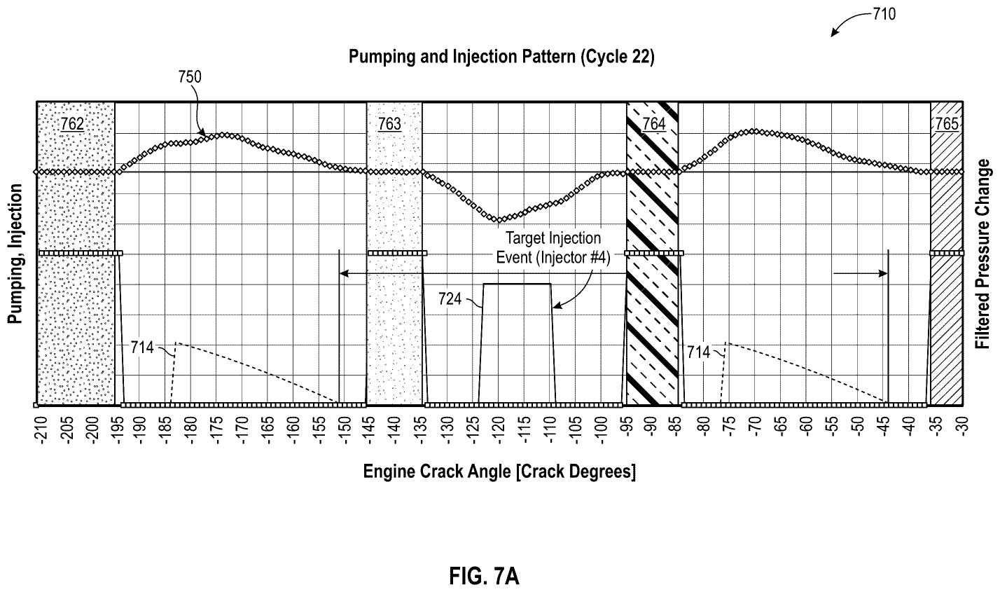

Precession parameters 210 and injection parameters 212 define a pumping and injection pattern for each engine cycle of a plurality of precessing engine cycles, for example, each of the 23 precessing engine cycles depicted in graph 600. PMZ requirements 206 provide requirements which can be applied to define and identify pressure measurement zones (PMZs). Filtered rail pressure 312 provides a sequential plurality of values input that can be evaluated or judged against PMZ requirements 206. By way of example, FIGS. 7, 8, and 9 depict graphs illustrating pumping patterns for example engine cycles defined by precession parameters 210 and injection parameters 212, a plurality of values of filtered rail pressure 312 and PMZs in which the values of filtered rail pressure 312 satisfy PMZ requirements 206.

FIG. 7 illustrates a pumping and injection pattern 710 corresponding to engine cycle 22 of the plurality of engine cycles of graph 600. Pumping and injection pattern 710 includes a plurality of pumping events 712 of a first plunger of the two-plunger high pressure fuel pump described above in connection with FIG. 6 and a plurality of pumping events 714 of a second plunger of the two-plunger high pressure fuel pump. Pumping and injection pattern 710 includes a plurality of injection events 721, 722, 723, 724, 725, and 726 corresponding, respectively, operation of fuel injector numbers 1, 2, 3, 4, 5, and 6 of a six-cylinder engine including the high pressure fuel pump.

FIG. 7 further illustrates a plurality of values 750 of filtered rail pressure 312 measured at a frequency of 10 kHz during engine cycle 22 and a plurality of PMZs 761, 762, 763, 764, 765, 766, 767, and 768 in which the values 750 of filtered rail pressure 312 satisfy PMZ requirements 206. PMZs 761, 762, 763, 764, 765, 766, 767, and 768 contain different numbers of data points or sequential discrete values of filtered rail pressure 312 as summarized in Table 1 below.

TABLE 1

| PMZ | Number of Data Points |
|---|---|
| 761 | 30 |
| 762 | 16 |
| 763 | 11 |
| 764 | 11 |
| 765 | 23 |
| 766 | 37 |
| 767 | 51 |
| 768 | 60 |

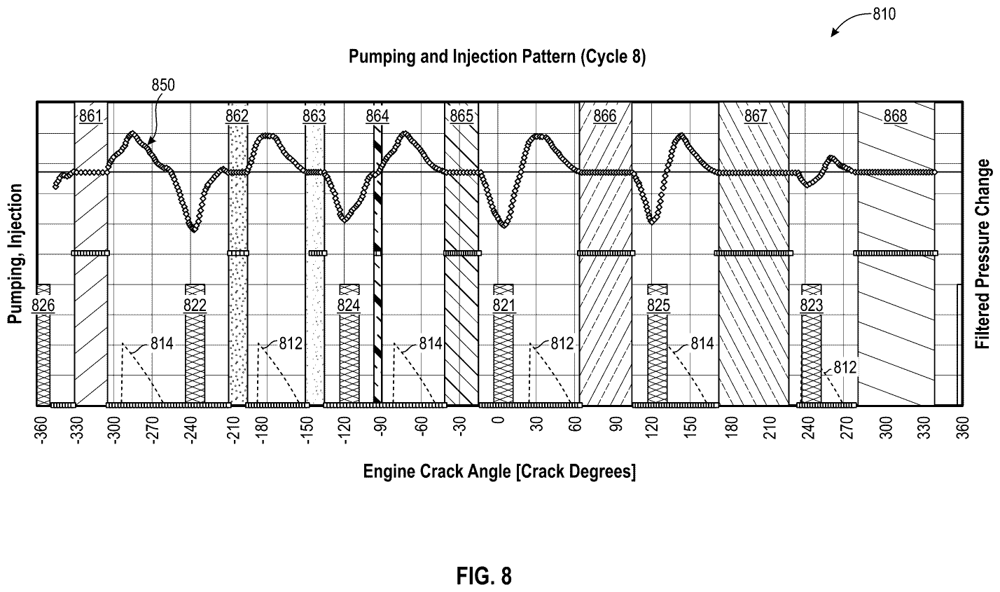

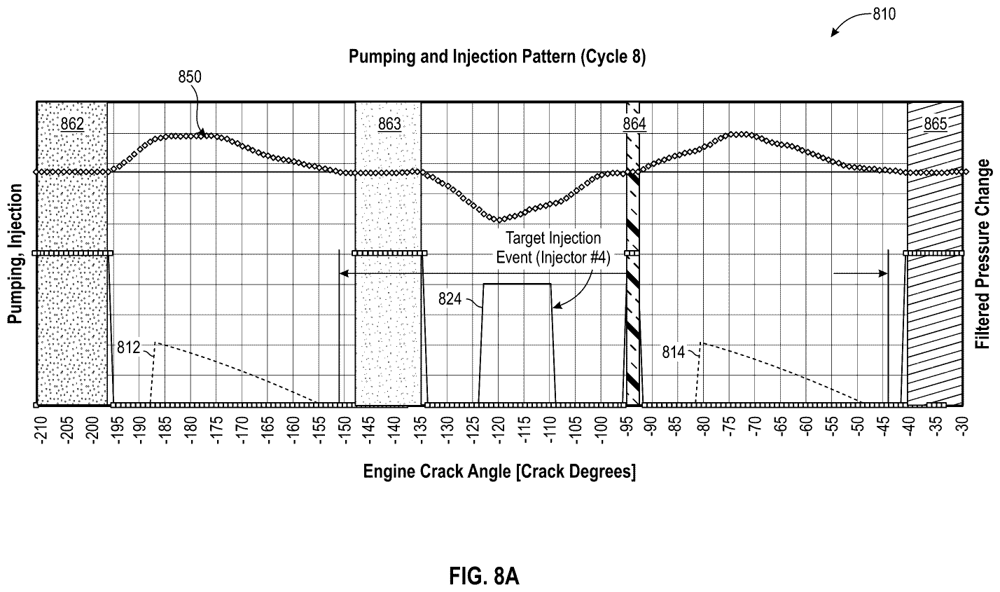

FIG. 8 illustrates a pumping and injection pattern 810 corresponding to engine cycle 8 of the plurality of engine cycles of graph 600. Pumping and injection pattern 810 includes a plurality of pumping events 812 of the first plunger and a plurality of pumping events 814 of the second plunger. Pumping and injection pattern 810 includes a plurality of injection events 821, 822, 823, 824, 825, and 826 corresponding, respectively to operation of fuel injector numbers 1, 2, 3, 4, 5, and 6.

FIG. 8 further illustrates a plurality of values 850 of filtered rail pressure 312 measured at a frequency of 10 kHz during engine cycle 8 and a plurality of PMZs 861, 862, 863, 864, 865, 866, 867, and 868 in which the values 850 of filtered rail pressure 312 satisfy PMZ requirements 206. PMZs 861, 862, 863, 864, 865, 866, 867, and 868 contain different numbers of data points or sequential discrete values of filtered rail pressure 312 as summarized in Table 2 below.

TABLE 2

| PMZ | Number of Data Points |
|---|---|
| 861 | 26 |
| 862 | 14 |
| 863 | 14 |
| 864 | 3 |
| 865 | 28 |
| 866 | 42 |
| 867 | 64 |
| 868 | 63 |

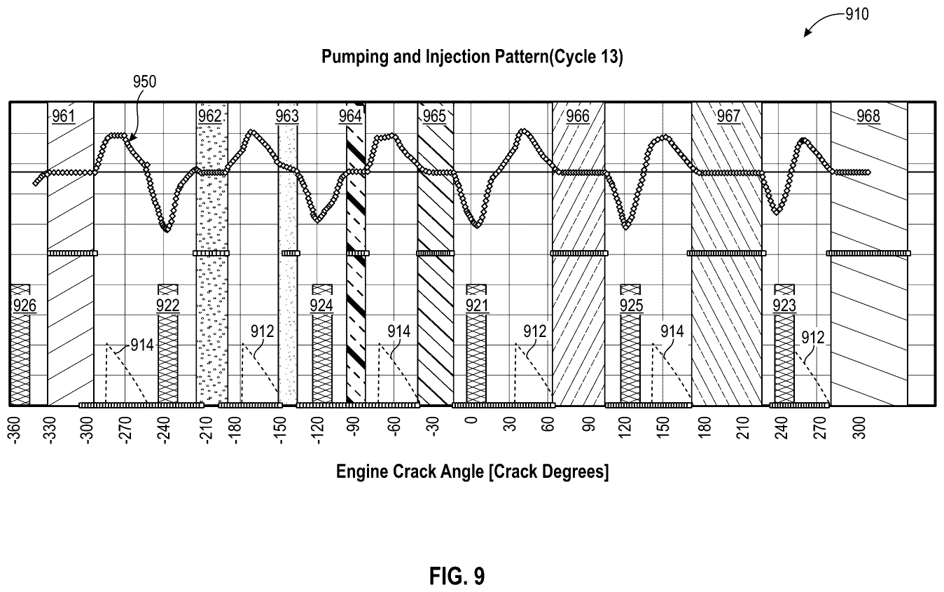

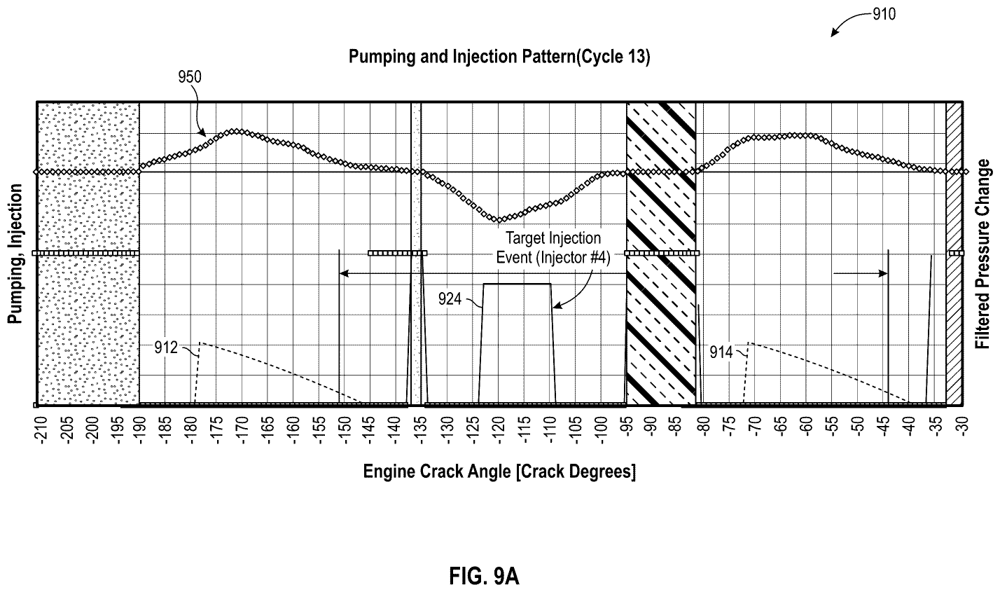

FIG. 9 illustrates a pumping and injection pattern 910 corresponding to engine cycle 13 of the plurality of engine cycles of graph 600. Pumping and injection pattern 910 includes a plurality of pumping events 912 of the first plunger and a plurality of pumping events 914 of the second plunger. Pumping and injection pattern 910 includes a plurality of injection events 921, 922, 923, 924, 925, and 926 corresponding, respectively to operation of fuel injector numbers 1, 2, 3, 4, 5, and 6.

FIG. 9 further illustrates a plurality of values 950 of filtered rail pressure 312 measured at a frequency of 10 kHz during engine cycle 8 and a plurality of PMZs 961, 962, 963, 964, 965, 966, 967, and 968 in which the values 850 of filtered rail pressure 312 satisfy PMZ requirements 206. PMZs 961, 962, 963, 964, 965, 966, 967, and 968 contain different numbers of data points or sequential discrete values of filtered rail pressure 312 as summarized in Table 3 below.

TABLE 3

| PMZ | Number of Data Points |
|---|---|
| 961 | 38 |
| 962 | 26 |
| 963 | 3 |
| 964 | 14 |
| 965 | 20 |
| 966 | 32 |
| 967 | 46 |
| 968 | 55 |

As illustrated by the examples of Tables 1-3 above, each of the 23 engine cycles of graph 600 a sequence of PMZs may be distinguished from PMZs of the other engine cycles by comparing or evaluating the duration of the sequence of PMZs for different engine cycles. It shall be appreciated that the term duration as used herein refers to and includes, for example, a time range, engine cycle or other angular range, number of data points or discrete filtered pressure measurements in a range, or other duration parameters. Thus, cycle number evaluator 420 may utilize the relative lengths of the PMZs of a given cycle and/or information of the duration of each PMZ of each cycle to determine a correspondence to the current cycle number. Information of each PMZ of each cycle may be obtained from observation of filtered rail pressure 312 or may be estimated based on information of the spacing of the injection and pumping events without requiring observation of filtered rail pressure 312. Cycle number evaluator 420 may also utilize information about the coincidence and spacing of injection and pumping events in particular inter-zone regions in identifying the current engine cycle. Using these techniques, cycle number evaluator 420 may determine and provide as output the cycle number 430.

Information of the duration of the PMZs need not be comprehensive or exhaustive of all PMZs for all cycles. In some embodiments, a subset of the total set of such information may be utilized to determine the current cycle number. By way of example, FIGS. 7A, 8A, and 9A illustrate enlarged portions of FIGS. 7, 8, and 9 which include injection events 724, 824, and 924 for the same injector (injector number 4 in the present example). The relative relationship of pumping events in different cycles which results in a predictable change in the lengths of all the zones. For example, in engine cycle 8, the pumping events are advanced (360/(2*39))≈4.615 engine crank degrees relative to the pumping timing events in engine cycle 22, and, in engine cycle 13, the pumping events are retarded (360/(2*39))≈4.615 engine crank degrees relative to the pumping timing events in engine cycle 22. The length of the zones (for example as indicated by the number of 10 kHz sampled filtered pressure) before and after injection events 724, 824, and 924 exhibits corresponding identifiable changes providing a basis for distinguishing among engine cycle numbers 8, 22, and 13 as summarized in Table 4 below.

TABLE 4

| | PMZ Data Points Before | PMZ Data Points After |
|---|---|---|
| Cycle | Injector 4 Event | Injector 4 Event |
| 8 | 14 | 3 |
| 22 | 11 | 11 |
| 13 | 2 | 14 |

It shall be appreciated that one or more additional comparisons of particular, zones, injection events, and/or pumping events may be utilized in distinguishing other engine cycles of a plurality of precessing engine cycles. It shall be further appreciated that the selection of particular, zones, injection events, and/or pumping events may vary for different pluralities of precessing engine cycles depending on their respective precessing parameters and the injection parameters provided to cycle number evaluator 420.

As illustrated by the foregoing examples, the cycle number evaluator 420 may identify a current engine cycle by evaluating or comparing zone lengths (e.g., time duration or equivalently engine cycle angle range or a number of data points or discrete measurements) before and after one or more injection and/or pumping events with expected zone length for each of a plurality of precessing engine cycles. The number of evaluations or comparisons may include all injection events or a subset thereof. The number of evaluations or comparisons may additionally or alternatively include all pumping events or a subset thereof. The number of evaluations or comparisons may additionally or alternatively include all pumping and all injection events or a subset thereof.

PMZ determination controls 306 may be configured and operable to perform one or more PMZ determinations associated with target event 204. For example, PMZ determination controls 306 may be configured and operable to predict one or more PMZs that are suitable for use in determining a pressure change and determining a fuel mass change for a particular target event. In some embodiments, PMZ determination controls 306 may be configured to predict a single PMZ as suitable. For example, for a given injection event, the PMZs with the longest duration both before and after the injection event may be selected as the predicted PMZ. This selection may be implemented by comparing the lesser of PMZ before and the PMZ after a given injection event for multiple engine cycles and selecting the engine cycle with the PMZ having the longest duration (e.g., time range, engine cycle range, number of data points or discrete filtered pressure measurements in a range, or other duration parameters).

In some embodiments, PMZ determination controls 306 may be additionally or alternatively configured and operable to predict one or more PMZs as suitable for use in determining a pressure change and determining a fuel mass change for a particular fuel mass change event. For example, for a given injection event, all PMZs with durations satisfying the conditions indicated by PMZ requirements 206 may be predicted as suitable.

PMZ determination controls 306 may utilize a number of techniques for predicting PMZs suitable for use in determining a pressure change and determining a fuel mass change for a particular fuel mass change event. For example, the PMZ determination controls 306 may compare or evaluate values of filtered rail pressure 312 preceding and following a given injection event for multiple different engine cycles relative to PMZ requirements 206 and select the single best PMZ relative to PMZ requirements 206 or one or more PMZs satisfying PMZ requirements 206. The comparison or evaluation may utilize a number of computational techniques including, for example, arithmetical or numeric comparison techniques, single or multiple objective function optimization techniques, process of elimination techniques, rank ordering techniques, and other techniques as will occur to one of skill in the art with the benefit and insight of the present disclosure. It shall be further appreciated that PMZ determination controls 306 may utilize techniques which are similar to the techniques described above in connection with cycle number determination controls 304 and such techniques with adaptations to change the resulting selection from determining an engine cycle determining one or more suitable PMZs.

PMZ determination controls 306 may be further configured and operable to validate PMZs predicted to be suitable for use in determining a pressure change and determining a fuel mass change for a particular fuel mass change event. It shall be appreciated that the terms validate and validation refer to and include comparison, confirmation, evaluation, testing, or other operations suitable for verification or validation of requirements. Such validation may utilize techniques which are the same as or similar to those described above in connection with prediction operations of PMZ determination controls 306. In some embodiments, the same techniques utilized for predicting suitable PMZ(s) may be repeated to validate suitability of the predicted PMZ(s). In some embodiments, similar but differing techniques as those utilized for predicting suitable PMZ(s) may be performed to validate suitability of the predicted PMZ(s). For example, as compared to the techniques used for validation, the techniques utilized for the predicting operations may utilize rougher approximations of PMZ duration such as approximations based on nominal values, heuristics, or other simplifying assumptions) which may streamline the net computational burden of PMZ determination controls 306. It shall be appreciated that the validation of PMZs predicted to be suitable for use in determining a pressure change and a fuel mass change for a particular fuel mass change event may include post-measurement and post-filtering validation of filtered rail pressures which may be utilized in determining the pressure change and the fuel mass change if validated or discarded or ignored if not validated.

Pressure change determination controls 308 may be configured and operable to determine a pressure change between PMZs before and after a given injection event that have been validated and found suitable for pressure change determinations (e.g., found to satisfy PMZ requirements 206). Pressure change determination controls 308 may utilize a number of techniques to determine a pressure change between PMZs before and after a given injection event including, for example, comparison or subtraction of average values of filtered rail pressure 312 (e.g., mean averages, median averages, weighted averages, or other averages) for PMZs before and after a given injection event, comparison or subtraction of sampled values of filtered rail pressure 312, or other techniques as will occur to one of skill in the art with the benefit and insight of the present disclosure.

Pressure change determination controls 308 may be configured and operable to first determine a net pressure change between PMZs before and after a given injection event that have been validated and found suitable for pressure change determinations. In some instances, the net pressure change may be for a region including a single fuel mass change event (e.g., a region between PMZs having a single injection event or a single pumping event). In such instances, the net pressure change may be taken and utilized as the pressure change for the single fuel mass change event itself. In other instances, the net pressure change may be for a region including multiple fuel mass change events (e.g., a region between PMZs having both an injection event and a pumping event). In such instances, pressure change determination controls 308 may remove (e.g., subtract, eliminate, factor out, mitigate, minimize, or otherwise remove) an effect of a confounding fuel mass change event that is not identified as the target event 204 and the resulting value may be taken and utilized as the pressure change for the target fuel mass change event. The removal of the effect of a confounding fuel mass change event may utilize estimated, nominal, previously determined, or other values for the confounding fuel mass change event. The removal of the effect of confounding fuel mass change events may be performed for multiple confounding fuel mass change events present for a given target event 204.

Fuel mass change determination controls 310 may be configured and operable to determine fuel mass change 233 which ideates a fuel mass change corresponding to the target event 204. Fuel mass change determination controls 310 may utilize a number of techniques to determine a fuel mass change 233. In some embodiments, fuel mass change determination controls 310 may be calculated or estimate a fuel mass change in accordance with equation (1):

$$Δ mass = Δ pressure * ( \frac{Vhps}{{c}^{2}} ) \qquad ( 1 )$$

where Δmass is the fuel mass change calculated or estimated by fuel mass change determination controls 310 and corresponding to the target event 204,
Δpressure is the pressure change determined by pressure change determination controls 308 and corresponding to the target event 204,
Vhps is the volume of the high pressure fuel system being evaluated, and
c is the sonic speed of fluid in the high pressure fuel system being evaluated.

For values of target event 204 corresponding to a pumping event of a high pressure fuel pump, fuel mass change 233 may be provided as input to pumping controls 252 which may be configured and operable to control operation of a high pressure fuel pump. Fuel mass change 233 is preferably sufficiently accurate and precise the be used in closed loop controls for fuel injectors and/or a high pressure fuel pump. Thus, for example, pumping controls 252 may be configured to increase or decrease the supply of fuel to high pressure fuel pump using closed loop controls such as by a PI controller, PID controller, or another closed loop controller to correct and reduce difference or error between of a determined fuel mass change of a pumping event from a commanded fuel mass change of a pumping event.

For values of target event 204 corresponding to a pumping event of a high pressure fuel pump, fuel mass change 233 may be provided as input to pumping diagnostic/prognostic controls 254 which may be configured and operable to perform one or more diagnostic and/or prognostic operations with respect to a high pressure fuel pump. For example, pumping diagnostic/prognostic controls 254 may be configured to identify or predict deterioration or malfunction of a high pressure fuel pump in response to values of fuel mass change 233 varying or deviating from a diagnostic or prognostic standard such as an error threshold or other standard.

For values of target event 204 corresponding to an injection event of a fuel injector, fuel mass change 233 may be provided as input to injection controls 256 which may be configured and operable to control operation of the respective injector. For example, injection controls 256 may be configured to increase or decrease a commanded injector on time, a commanded rail pressure, and/or an injection timing using closed loop controls such as by a PI controller, PID controller, or another closed loop controller to correct and reduce deviation of a determined fuel mass change of an injection event from a commanded fuel mass change for the injection event.

For values of target event 204 corresponding to an injection event of a fuel injector, fuel mass change 233 may be provided as input to injection diagnostic/prognostic controls 258 which may be configured and operable to perform one or more diagnostic and/or prognostic operations with respect to a fuel injector. For example, pumping diagnostic/prognostic controls 254 may be configured to identify or predict deterioration or malfunction of a fuel injector in response to values of fuel mass change 233 varying or deviating from a diagnostic or prognostic standard such as an error threshold or other standard.

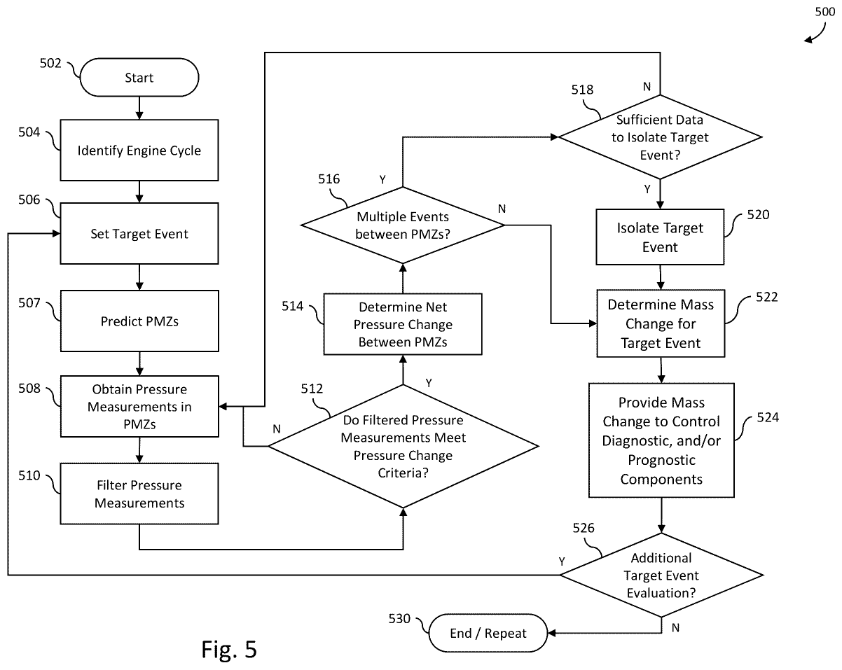

With reference to FIG. 5, there is illustrated an example control method which may be performed by one or more components of an electronic control system such as ECS 20 of engine system 11, another electronic control system of engine system 11, or another electronic control system of another engine system. Such components may, for example, be configured to implement and operate engine system controls such as engine system controls 200 or other engine system controls.

Method 500 begins at start operation 502 and proceeds to operation 504 which identifies engine cycle such as a current engine cycle. Operation 504 may identify an engine cycle in accordance with the techniques described in connection with cycle number determination controls 304 described above in connection with engine system controls 200. From operation 504, method 500 proceeds to operation 506 which sets a target event. Operation 506 may set a target event as one of the values or target events described above in connection with target event 204.

From operation 506, method 500 proceeds to operation 507 which predicts one or more PMZs as suitable for use in determining a pressure change and determining a fuel mass change for a particular fuel mass change event. Operation 507 may predict one or more PMZs in accordance with the prediction operations of PMZ determination controls 306. From operation 507, method 500 proceeds to operation 508 which obtains pressure measurements for the predicted PMZs. From operation 508, method 500 proceeds to operation 510 which filters the obtained pressure measurements. Operations 508 and 510 may operate in accordance with the techniques described in connection with pressure filtering controls 302 and PMZ determination controls 306.

From operation 510, method 500 proceeds to conditional 512 which evaluates whether the filtered measurements meet or satisfy one or more pressure change criteria. Conditional 512 may perform this evaluation in accordance with the validation operations described in connection with PMZ determination controls 306. If conditional 512 evaluates negative, method 500 proceeds to operation 508. If conditional 512 evaluates affirmative, method 500 proceeds to operation 514 which determines a net pressure change between the PMZ preceding the target event and the PMZ following the target event. Operation 514 may determine a net pressure change in accordance with the techniques described in connection with pressure change determination controls 308.

From operation 514, method 500 proceeds to conditional 516 which evaluates whether multiple events (e.g., a target fuel mass change event and one or more confounding fuel mass change events, such as an injection event and a pumping event) are present between the PMZ preceding the target event and the PMZ following the target event. If conditional 516 evaluates negative, method 500 proceeds to operation 522 which is further described below. If conditional 516 evaluates affirmative, method 500 proceeds to conditional 518 which evaluates whether sufficient data or information regarding the one or more confounding fuel mass change event is available to isolate the target fuel mass change event. If conditional 518 evaluates negative, method 500 proceeds to operation 508. If conditional 518 evaluates affirmative, method 500 proceeds to operation 520 which isolates the target fuel mass change event. Operations 518 and 520 may operate in accordance with the techniques described in connection with pressure change determination controls 308.

From operation 520, method 500 proceeds operation 522 which determines a fuel mass change corresponding to a target fuel mass change event. Operation 522 may operate in accordance with the techniques described in connection with fuel mass change determination controls 310. From operation 522, method 500 proceeds to operation 524 which provides the fuel mass change determined by operation 522 to one or more of pumping controls (e.g., pumping controls 252), pumping diagnostics and/or prognostics (e.g., pumping diagnostic/prognostic controls 254), injection controls (e.g., injection controls 256), injection diagnostics and/or prognostics (e.g., injection diagnostic/prognostic controls 258). From operation 524, method 500 proceeds to conditional 526 which evaluates whether method 500 should be performed with respect to additional target events. As described above, method 500 may be repeated for one or injection events corresponding to one or more particular injectors, one or more public events corresponding to one or more operations of a high pressure fuel pump, or combinations thereof up to and including all such injection events and/or all such pumping events. If conditional 526 evaluates affirmative, method 500 proceeds to operation 506. If conditional 526 evaluates negative, method 500 proceeds to operation 530 where method 500 ends and may subsequently be repeated.

Further written description of a number of example embodiments is now provided. A first example embodiment is a method comprising: operating a fuel system including operating a pump to pump fuel to a rail and concurrently operating one or more injectors to inject fuel from the rail into one or more cylinders of an engine; filtering measurements of fuel pressure of the rail taken during the operating to determine filtered pressures for a first pressure measurement zone preceding a target fuel mass change event of the fuel system and a second pressure measurement zone succeeding the target fuel mass change event; determining a pressure change in response to the filtered pressures of the first pressure measurement zone and the second pressure measurement zone if the filtered pressures of the first pressure measurement zone and the second pressure measurement zone satisfy a pressure change requirement; determining a fuel mass change corresponding to the target fuel mass change event in response to the pressure change; and at least one of controlling and diagnosing one of the one or more injectors and the pump in response to the fuel mass change.

A second example embodiment is a method including the features of the first example embodiment, comprising: prior to the filtering, identifying a specific engine cycle as one of a plurality of precessing engine cycles, each of the plurality of precessing engine cycles having different phasing of the pump relative to the engine.

A third example embodiment is a method including the features of the second example embodiment, wherein the identifying comprises comparing a plurality of measured characteristics of the specific engine cycle with corresponding pluralities of previously determined characteristics each of the plurality of precessing engine cycles.

A fourth example embodiment is a method including the features of the third example embodiment, wherein the plurality of measured characteristics comprise one or more of: an injection duration of one or more injection events, a pumping duration of one or more pumping events, and a pressure measurement zone duration of one or more pressure measurement zones satisfying the pressure change requirement.

A fifth example embodiment is a method including the features of any one of the first through fourth example embodiments, wherein the determining the pressure change of the target fuel mass change event comprises determining a net pressure change between the first pressure measurement zone and the second pressure measurement zone, and removing remove an effect of a confounding fuel mass change event from the net pressure change.

A sixth example embodiment is a method including the features of any one of the first through fourth example embodiments, wherein the filtering is effective to mitigate ringing/oscillation in the measurements.

A seventh example embodiment is a method including the features of any one of the first through fourth example embodiments, comprising: prior to the filtering, predicting the first pressure measurement zone and the second pressure measurement zone.

An eighth example embodiment is a method including the features of the seventh example embodiment, wherein the pressure change requirement comprises a maximum pressure change limit and the predicting the first pressure measurement zone and the second pressure measurement zone is based at least in part upon the maximum pressure change limit.

An ninth example embodiment is a method including the features of the eighth example embodiment, wherein the maximum pressure change limit is defined relative to a steady state pressure decay rate.

A tenth example embodiment is a method including the features of any one of the first through fourth example embodiments, wherein the target fuel mass change event is settable as either an injection by a particular one of the one or more injectors or a pumping by the pump.

An eleventh example embodiment is a system comprising: a fuel system including a pump configured to pump fuel to a rail and one or more injectors to inject fuel from the rail into one or more cylinders of an engine; and an electronic control system configured to perform the acts of: filtering measurements of fuel pressure of the rail taken during operation of the pump and the one or more injectors to determine filtered pressures for a first pressure measurement zone preceding a target fuel mass change event of the fuel system and a second pressure measurement zone succeeding the target fuel mass change event, determining a pressure change in response to the filtered pressures of the first pressure measurement zone and the second pressure measurement zone if the filtered pressures of the first pressure measurement zone and the second pressure measurement zone satisfy a pressure change requirement, determining a fuel mass change corresponding to the target fuel mass change event in response to the pressure change, and at least one of controlling and diagnosing a selected one of the particular one of the one or more injectors and the pump in response to the fuel mass change.

A twelfth example embodiment is a system including the features of the eleventh example embodiment, wherein the electronic control system configured to perform the act of identifying a specific engine cycle as one of a plurality of precessing engine cycles, each of the plurality of precessing engine cycles having different phasing of the pump relative to the engine.

A thirteenth example embodiment is a system including the features of the twelfth example embodiment, wherein the identifying comprises comparing a plurality of measured characteristics of the specific engine cycle measurements with corresponding pluralities of previously determined characteristics each of the plurality of precessing engine cycles.

A fourteenth example embodiment is a system including the features of the thirteenth example embodiment, wherein the plurality of measured characteristics comprise one or more of: an injection duration of one or more injection events, a pumping duration of one or more pumping events, and a pressure measurement zone duration of one or more pressure measurement zones satisfying the pressure change requirement.

A fifteenth example embodiment is a system including the features of any one of the eleventh through fourteenth example embodiments, wherein the determining the pressure change of the target fuel mass change event comprises determining a net pressure change between the first pressure measurement zone and the second pressure measurement zone, and removing remove an effect of a confounding fuel mass change event from the net pressure change.

A sixteenth example embodiment is a system including the features of any one of the eleventh through fourteenth example embodiments, wherein the filtering is effective to mitigate ringing/oscillation in the measurements.

A seventeenth example embodiment is a system including the features of any one of the eleventh through fourteenth example embodiments, wherein the electronic control system is configured to perform the act of predicting the first pressure measurement zone and the second pressure measurement zone.

An eighteenth example embodiment is a system including the features of the seventeenth example embodiment, wherein the pressure change requirement comprises a maximum pressure change limit and the predicting the first pressure measurement zone and the second pressure measurement zone is based at least in part upon the maximum pressure change limit.

An nineteenth example embodiment is a system including the features of the eighteenth example embodiment, wherein the maximum pressure change limit is defined relative to a steady state pressure decay rate.

A twentieth example embodiment is a system including the features of any one of the eleventh through fourteenth example embodiments, wherein the target fuel mass change event is settable as either an injection by a particular one of the one or more injectors or a pumping by the pump.

A twenty-first example embodiment is an apparatus for controlling operation of a fuel system including a pump configured to pump fuel to a rail and one or more injectors to inject fuel from the rail into one or more cylinders of an engine, the apparatus comprising: one or more non-transitory memory media configured with instructions executable by one or more processors of an electronic control system to perform acts of: filtering measurements of fuel pressure of the rail taken during operation of the pump and the one or more injectors to determine filtered pressures for a first pressure measurement zone preceding a target fuel mass change event of the fuel system and a second pressure measurement zone succeeding the target fuel mass change event, determining a pressure change in response to the filtered pressures of the first pressure measurement zone and the second pressure measurement zone if the filtered pressures of the first pressure measurement zone and the second pressure measurement zone satisfy a pressure change criterion, determining a fuel mass change corresponding to the target fuel mass change event in response to the pressure change, and at least one of controlling and diagnosing a selected one of the particular one of the one or more injectors and the pump in response to the fuel mass change.

A twenty-second example embodiment is an apparatus including the features of the twenty-first example embodiment, wherein the instructions are executable by the electronic control system configured to perform the act of identifying a particular engine cycle as one of a plurality of repeating engine cycles, each of the plurality of repeating engine cycles having different phasing of the pump relative to the engine.

A twenty-third example embodiment is an apparatus including the features of the twenty-second example embodiment, wherein the identifying comprises comparing a plurality of measured characteristics of the particular engine cycle measurements with corresponding pluralities of previously determined characteristics each of the plurality of repeating engine cycles.

A twenty-fourth example embodiment is an apparatus including the features of the twenty-third example embodiment, wherein the plurality of measured characteristics comprise one or more of: an injection duration of one or more injection events, a pumping duration of one or more pumping events, and a pressure measurement zone duration of one or more pressure measurement zones satisfying the pressure change criterion.

A twenty-fifth example embodiment is an apparatus including the features of any one of the twenty-first through twenty-fourth example embodiments, wherein the determining the pressure change of the target fuel mass change event comprises determining a net pressure change between the first pressure measurement zone and the second pressure measurement zone, and removing remove an effect of a confounding fuel mass change event from the net pressure change.

A twenty-sixth example embodiment is an apparatus including the features of any one of the twenty-first through twenty-fourth example embodiments, wherein the filtering is effective to mitigate ringing/oscillation in the measurements.

A twenty-seventh example embodiment is an apparatus including the features of any one of the twenty-first through twenty-fourth example embodiments, wherein the instructions are executable by the electronic control system configured to perform the act of predicting the first pressure measurement zone and the second pressure measurement zone.

A twenty-eighth example embodiment is an apparatus including the features of the twenty-seventh example embodiment, wherein the predicting the first pressure measurement zone and the second pressure measurement zone is based at least in part upon a maximum pressure change criterion.

A twenty-ninth example embodiment is an apparatus including the features of the twenty-eighth example embodiment, wherein the maximum pressure change criterion is defined relative to a steady state pressure decay rate.

A thirtieth example embodiment is an apparatus including the features of any one of the twenty-first through twenty-fourth example embodiments, wherein the target fuel mass change event is settable as either an injection by a particular one of the one or more injectors or a pumping by the pump.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method comprising:
operating a fuel system including operating a pump to pump fuel to a rail and concurrently operating one or more injectors to inject fuel from the rail into one or more cylinders of an engine;
filtering measurements of fuel pressure of the rail taken during the operating to determine filtered pressures for a first pressure measurement zone preceding a target fuel mass change event of the fuel system and a second pressure measurement zone succeeding the target fuel mass change event;
determining a pressure change in response to the filtered pressures of the first pressure measurement zone and the second pressure measurement zone if the filtered pressures of the first pressure measurement zone and the second pressure measurement zone satisfy a pressure change requirement;
determining a fuel mass change corresponding to the target fuel mass change event in response to the pressure change; and
at least one of controlling and diagnosing one of the one or more injectors and the pump in response to the fuel mass change.

2. The method of claim 1, comprising: prior to the filtering, identifying a specific engine cycle as one of a plurality of precessing engine cycles, each of the plurality of precessing engine cycles having different phasing of the pump relative to the engine.

3. The method of claim 2, wherein the identifying comprises comparing a plurality of measured characteristics of the specific engine cycle with corresponding pluralities of previously determined characteristics each of the plurality of precessing engine cycles.

4. The method of claim 3, wherein the plurality of measured characteristics comprise one or more of: an injection duration of one or more injection events, a pumping duration of one or more pumping events, and a pressure measurement zone duration of one or more pressure measurement zones satisfying the pressure change requirement.

5. The method of claim 1, wherein the determining the pressure change of the target fuel mass change event comprises determining a net pressure change between the first pressure measurement zone and the second pressure measurement zone, and removing remove an effect of a confounding fuel mass change event from the net pressure change.

6. The method of claim 1, wherein the filtering is effective to mitigate ringing/oscillation in the measurements.

7. The method of claim 1, comprising: prior to the filtering, predicting the first pressure measurement zone and the second pressure measurement zone.

8. The method of claim 7, wherein the pressure change requirement comprises a maximum pressure change limit and the predicting the first pressure measurement zone and the second pressure measurement zone is based at least in part upon the maximum pressure change limit.

9. The method of claim 8, wherein the maximum pressure change limit is defined relative to a steady state pressure decay rate.

10. The method of claim 1, wherein the target fuel mass change event is settable as either an injection by a particular one of the one or more injectors or a pumping by the pump.

11. A system comprising:
a fuel system including a pump configured to pump fuel to a rail and one or more injectors to inject fuel from the rail into one or more cylinders of an engine; and
an electronic control system configured to perform the acts of:
filtering measurements of fuel pressure of the rail taken during operation of the pump and the one or more injectors to determine filtered pressures for a first pressure measurement zone preceding a target fuel mass change event of the fuel system and a second pressure measurement zone succeeding the target fuel mass change event,
determining a pressure change in response to the filtered pressures of the first pressure measurement zone and the second pressure measurement zone if the filtered pressures of the first pressure measurement zone and the second pressure measurement zone satisfy a pressure change requirement,
determining a fuel mass change corresponding to the target fuel mass change event in response to the pressure change, and
at least one of controlling and diagnosing a selected one of the particular one of the one or more injectors and the pump in response to the fuel mass change.

12. The system of claim 11, wherein the electronic control system configured to perform the act of identifying a specific engine cycle as one of a plurality of precessing engine cycles, each of the plurality of precessing engine cycles having different phasing of the pump relative to the engine.

13. The system of claim 12, wherein the identifying comprises comparing a plurality of measured characteristics of the specific engine cycle measurements with corresponding pluralities of previously determined characteristics each of the plurality of precessing engine cycles.

14. The system of claim 13, wherein the plurality of measured characteristics comprise one or more of: an injection duration of one or more injection events, a pumping duration of one or more pumping events, and a pressure measurement zone duration of one or more pressure measurement zones satisfying the pressure change requirement.

15. The system of claim 11, wherein the determining the pressure change of the target fuel mass change event comprises determining a net pressure change between the first pressure measurement zone and the second pressure measurement zone, and removing remove an effect of a confounding fuel mass change event from the net pressure change.

16. The system of claim 11, wherein the filtering is effective to mitigate ringing/oscillation in the measurements.

17. The system of claim 11, wherein the electronic control system is configured to perform the act of predicting the first pressure measurement zone and the second pressure measurement zone.

18. The system of claim 17, wherein the pressure change requirement comprises a maximum pressure change limit and the predicting the first pressure measurement zone and the second pressure measurement zone is based at least in part upon the maximum pressure change limit.

19. The system of claim 18, wherein the maximum pressure change limit is defined relative to a steady state pressure decay rate.

20. The system of claim 11, wherein the target fuel mass change event is settable as either an injection by a particular one of the one or more injectors or a pumping by the pump.

21. An apparatus for controlling operation of a fuel system including a pump configured to pump fuel to a rail and one or more injectors to inject fuel from the rail into one or more cylinders of an engine, the apparatus comprising:
one or more non-transitory memory media configured with instructions executable by one or more processors of an electronic control system to perform acts of:
filtering measurements of fuel pressure of the rail taken during operation of the pump and the one or more injectors to determine filtered pressures for a first pressure measurement zone preceding a target fuel mass change event of the fuel system and a second pressure measurement zone succeeding the target fuel mass change event,
determining a pressure change in response to the filtered pressures of the first pressure measurement zone and the second pressure measurement zone if the filtered pressures of the first pressure measurement zone and the second pressure measurement zone satisfy a pressure change criterion,
determining a fuel mass change corresponding to the target fuel mass change event in response to the pressure change, and
at least one of controlling and diagnosing a selected one of the particular one of the one or more injectors and the pump in response to the fuel mass change.

22. The apparatus of claim 21, wherein the instructions are executable by the electronic control system configured to perform the act of identifying a particular engine cycle as one of a plurality of repeating engine cycles, each of the plurality of repeating engine cycles having different phasing of the pump relative to the engine.

23. The apparatus of claim 22, wherein the identifying comprises comparing a plurality of measured characteristics of the particular engine cycle measurements with corresponding pluralities of previously determined characteristics each of the plurality of repeating engine cycles.

24. The apparatus of claim 23, wherein the plurality of measured characteristics comprise one or more of: an injection duration of one or more injection events, a pumping duration of one or more pumping events, and a pressure measurement zone duration of one or more pressure measurement zones satisfying the pressure change criterion.

25. The apparatus of claim 21 wherein the determining the pressure change of the target fuel mass change event comprises determining a net pressure change between the first pressure measurement zone and the second pressure measurement zone, and removing remove an effect of a confounding fuel mass change event from the net pressure change.

26. The apparatus of claim 21, wherein the filtering is effective to mitigate ringing/oscillation in the measurements.

27. The apparatus of claim 21, wherein the instructions are executable by the electronic control system configured to perform the act of predicting the first pressure measurement zone and the second pressure measurement zone.

28. The apparatus of claim 27, wherein the predicting the first pressure measurement zone and the second pressure measurement zone is based at least in part upon a maximum pressure change criterion.

29. The apparatus of claim 28, wherein the maximum pressure change criterion is defined relative to a steady state pressure decay rate.

30. The apparatus of claim 21, wherein the target fuel mass change event is settable as either an injection by a particular one of the one or more injectors or a pumping by the pump.
